(19) United States
(12) Patent Application Publication
(10) Pub. No.: US 2015/0205159 A1
(43) Pub. Date: Jul. 23, 2015

(54) DISPLAY DEVICE

(71) Applicant: Japan Display Inc., Minato-ku (JP)

(72) Inventors: Osamu ITOU, Tokyo (JP); Takato HIRATSUKA, Tokyo (JP)

(73) Assignee: Japan Display Inc., Minato-ku (JP)

(21) Appl. No.: 14/601,394

(22) Filed: Jan. 21, 2015

(30) Foreign Application Priority Data
Jan. 22, 2014 (JP) 2014-009280

(51) Int. Cl. G02F 1/1335

(52) U.S. Cl. CPC G02F 1/133504; G02F 1/133512; G02F 1/133553; G02F 2001/133507

(57) ABSTRACT

A display device includes a light source, a substrate transparent to a light source light, a pixel portion disposed at a side irradiated with the light source light, and a light extraction structure for extracting the light from the pixel portion to the outside. The light extraction structure includes a wall-like structure and a reflection layer. The pixel portion includes a laminated film formed by laminating the wavelength conversion layer for emitting fluorescent light through radiation of the light source light, and an excitation light absorbing layer disposed between the wavelength conversion layer and the substrate. The laminated film is disposed in the region partitioned by walls of the wall-like structure.

### CLAIM OF PRIORITY

The present application claims priority from Japanese patent application JP 2014-9280 filed on Jan. 22, 2014, the content of which is hereby incorporated by reference into this application.

### TECHNICAL FIELD

The present invention relates to a display device which employs a wavelength conversion layer such as a fluorophor.

### BACKGROUND

The liquid crystal display device having a color filter has been widely distributed because of such features as high display quality, thin and light-weight structure, and low power consumption. Such device has been used for various applications including the monitor for mobile phone or mobile device such as a digital still camera, the monitor for desktop PC, the monitor adapted for printing and design, the monitor for medical use, and the liquid crystal TV. Along with the broadened applications, the liquid crystal display device is demanded to further realize high image quality or high quality, especially, strongly demanded to achieve the high brightness by intensifying transmittance as well as low power consumption. As use of the liquid crystal display device has become widespread, the cost reduction is also strongly required.

Meanwhile, the display device which employs the fluorophor instead of the color filter is disclosed in Japanese Patent Application Laid-Open No. 2012-118239 and Japanese Patent Application Laid-Open No. 2013-109907.

### SUMMARY OF THE INVENTION

The liquid crystal display device is configured to carry out the color display by absorbing the white light source using the color filter. The aforementioned liquid crystal display device expands the color reproduction range to deepen color of the color filter, thus reducing the transmittance. In other words, the color filter is a main cause of deterioration in efficiency (brightness degradation) of the liquid crystal display device.

The color display method without using the color filter may be carried out through the field sequential process or use of the display device with the wavelength conversion layer such as the fluorophor instead of the color filter (hereinafter referred to as the fluorescent display device). The field sequential process is designed to carry out the color display by switching the backlight among those of red, blue and green in synchronization. However, it is difficult for the process to eliminate flickering in the switching operation.

The fluorophor type display device is configured to carry out the color display by using the light source, for example, the blue light source or the near-ultraviolet light source to absorb the light source light by the wavelength conversion layer, and to emit fluorescent light for converting the light source light into the red or green light with longer wavelength. The fluorophor is the material for emitting the light with wavelength longer than the excitation light through irradiation of the light with short wavelength (excitation light), which exhibits the high conversion efficiency (80%). However, the fluorescent light generated in the wavelength conversion layer propagates isotropically. The light extraction structure (wall structure with the reflection layer) as proposed in Japanese Patent Application Laid-Open No. 2013-109907 is effective for increasing the ratio at which the fluorescent light reaches the user's side.

The fluorescent display device with light extraction structure has been prepared and evaluated by the present inventors. It has been found to provide the display device with higher brightness than that of the liquid crystal display device. However, the display device has also been found to have deterioration in the image quality, for example, reduced contrast ratio or deteriorated color purity in the outdoor environment.

The present invention provides the display device which exhibits high brightness and high image quality even in an outdoor environment.

The present invention provides a display device which includes a light source, a substrate transparent to a light source light radiated from the light source, a pixel portion disposed on the substrate at a side irradiated with the light source light, and a light extraction structure which extracts a light from the pixel portion to the outside. The light extraction structure includes a wall-like structure and a reflection layer disposed along a side wall of the wall-like structure. The pixel portion includes a laminated film formed by laminating a wavelength conversion layer which emits the light with longer wavelength than that of the light source light through radiation thereof, and an excitation light absorbing layer disposed between the wavelength conversion layer and the substrate for suppressing transmission of the light with wavelength other than the one of the light with the longer wavelength. The laminated film is disposed in a region partitioned by walls of the wall-like structure.

The present invention further provides a display device which includes a light source, a substrate transparent to a light source light radiated from the light source, a first pixel portion, a second pixel portion and a third pixel portion which are disposed on the substrate at a side irradiated with the light source light, and a light extraction structure for extracting the light from the first portion, the second portion, and the third pixel portion to the outside. The light extraction structure includes a wall-like structure and a reflection layer disposed along a side wall of the wall-like structure. The first pixel portion includes a first laminated film formed by laminating a first wavelength conversion layer for emitting a first light with longer wavelength than that of the light source light through radiation thereof, and a first excitation light absorbing layer disposed between the first wavelength conversion layer and the substrate for suppressing transmission of the light with wavelength other than the one of the first light. The second pixel portion includes a second laminated film formed by laminating a second wavelength conversion layer for emitting a second light with longer wavelength than that of the light source light through radiation thereof, and a second excitation light absorbing layer disposed between the second wavelength conversion layer and the substrate for suppressing transmission of the light with wavelength other than the one of the second light. The third pixel portion includes a light source light scattering layer made of a transparent film having microparticles with high refractive index dispersed. The first laminated film, the second laminated film and the light source light scattering layer are disposed in corresponding regions partitioned by the walls of the wall-like structure.

The present invention still further provides a display device which includes a light source, a substrate transparent to a light source light radiated from the light source, a first pixel portion, a second pixel portion and a third pixel portion which are disposed on the substrate at a side irradiated with the light source light, and a light extraction structure for extracting the light from the first portion, the second portion, and the third pixel portion to the outside. The light extraction structure includes a wall-like structure and a reflection layer disposed along a side wall of the wall-like structure. The first pixel portion includes a first laminated film formed by laminating a first wavelength conversion layer for emitting a first light with longer wavelength than that of the light source light through radiation thereof, and a first excitation light absorbing layer disposed between the first wavelength conversion layer and the substrate for suppressing transmission of the light with wavelength other than the one of the first light. The second pixel portion includes a second laminated film formed by laminating a second wavelength conversion layer for emitting a second light with longer wavelength than that of the light source light through radiation thereof, and a second excitation light absorbing layer disposed between the second wavelength conversion layer and the substrate for suppressing transmission of the light with wavelength other than the one of the second light. The third pixel portion includes a third laminated film formed by laminating a third wavelength conversion layer for emitting a third light with longer wavelength than that of the light source light through radiation thereof, and a third excitation light absorbing layer disposed between the third wavelength conversion layer and the substrate for suppressing transmission of the light with wavelength other than the one of the third light. The first laminated film, the second laminated film and the third laminated film are disposed in corresponding regions partitioned by the walls of the wall-like structure.

### BRIEF DESCRIPTION OF THE DRAWINGS

FIG. 1 is a sectional view of a main part of a display device of a first embodiment according to the present invention;

FIG. 2 is a schematic view for explaining a wavelength conversion layer of a red pixel and the optical path of the excitation light and fluorescent light around the layer in the display device of the first embodiment according to the present invention;

FIG. 3 is a schematic view for explaining the wavelength conversion layer of the red pixel and optical path of the external light around the layer in the display device of the first embodiment according to the present invention;

FIG. 4 is a sectional view of a main part of another type of the display device of the first embodiment according to the present invention;

FIG. 5 is a sectional view of a main part of a display device of a second embodiment according to the present invention;

FIG. 6 is a sectional view of a main part of a display device of a third embodiment according to the present invention;

FIG. 7 is a schematic view for explaining the wavelength conversion layer of the red pixel and the optical path of the excitation light and fluorescent light around the layer in the display device of the third embodiment according to the present invention;

FIG. 8 is a sectional view of a main part of a display device of a fourth embodiment according to the present invention;

FIG. 9 is a schematic view for explaining the wavelength conversion layer of the red pixel and the optical path of the excitation light and fluorescent light around the layer in the display device of the fourth embodiment according to the present invention;

FIG. 10 is a sectional view of a main part of a display device of a fifth embodiment according to the present invention;

FIG. 11 is a schematic view for explaining the wavelength conversion layer of the red pixel and the optical path of the external light around the layer in the display device of the fifth embodiment according to the present invention;

FIG. 12 is a sectional view of a main part of a display device of a sixth embodiment according to the present invention;

FIG. 13 is a sectional view of a main part of the display device of the sixth embodiment according to the present invention;

FIG. 14 is a schematic view for explaining the wavelength conversion layer of the red pixel and the optical path of the excitation light and fluorescent light around the layer in the display device of the sixth embodiment according to the present invention;

FIG. 15 is a flowchart of manufacturing steps of a substrate for forming the wavelength conversion layer of the display device of the first embodiment according to the present invention;

FIG. 16A is a perspective view illustrating an example of a wall-like structure (stripe pattern) that constitutes a light extraction structure of the display device according to any one of the first to sixth embodiments of the present invention;

FIG. 16B is a perspective view illustrating another example of the wall-like structure (waffle pattern) that constitutes the light extraction structure of the display device in accordance with any one of the first to sixth embodiments of the present invention; and

FIG. 17 is a plan view of the display device in accordance with any one of the first to sixth embodiments of the present invention.

### DESCRIPTION OF THE PREFERRED EMBODIMENTS

On the assumption that the external light causes degradation in the image quality especially notable in the outdoor environment, an excitation light absorbing layer is disposed for suppressing the influence of the external light by the present inventors. It has been clarified that the mere provision of the excitation light absorbing layer may fail to provide the effect for sufficiently lessening the influence of the external light depending on the alignment of the excitation light absorbing layer with the position at which the wavelength is converted. For this, the excitation light absorbing layer and the wavelength conversion layer are laminated in the region partitioned by walls of the wall-like structure which constitutes the light extraction structure. This makes it possible to effectively lessen the influence of the external light without generating positional displacement between the respectively laminated layers. The present invention has been made in consideration of the above-described findings.

Embodiments according to the present invention will be described hereinafter referring to the drawings.

Those embodiments are only examples, and it is to be understood that those who skilled in the art make any modification or change which can be easily thought within the scope of the present invention. Each drawing may be shown schematically with respect to the width, thickness, shape and the like compared with the actual state. They are still examples which will not limit the present invention.

In the specification and the drawings, the element which has been described referring to the drawing will be designated with the same code, and explanation thereof, thus will be omitted.

### First Embodiment

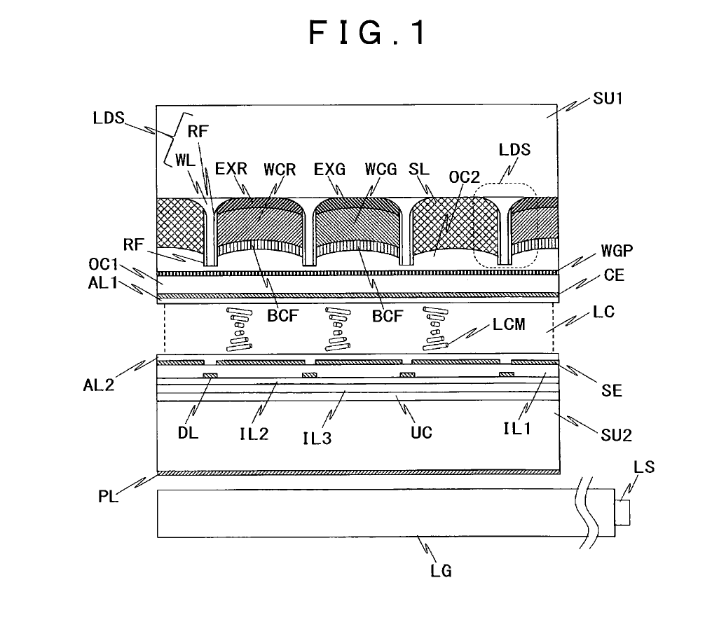

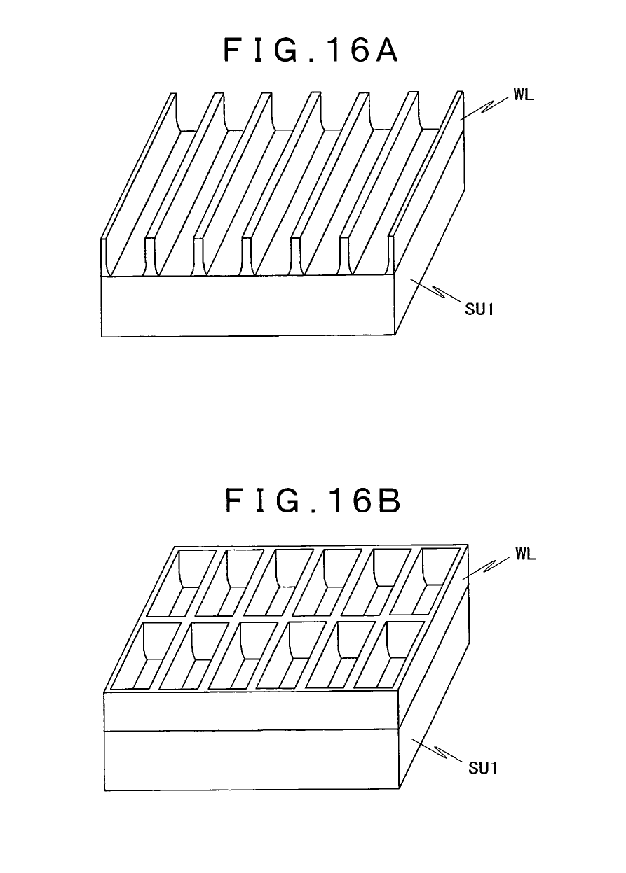

A display device (liquid crystal display device) of a first embodiment according to the present invention will be described referring to FIGS. 1 to 4, 15, 16A, 16B and 17. FIG. 1 is a sectional view of a main part of the liquid crystal display device of the embodiment, which includes three pixels of red, green and blue. The liquid crystal display device is configured to interpose a liquid crystal layer LC between a first substrate SU1 and a second substrate SU2. A first orientation film AL1, a common electrode CE, a first planarization layer OC1, a polarizing layer WGP, and a second planarization layer OC2 are sequentially laminated on the first substrate SU1 from the side adjacent to the liquid crystal layer LC. A stray light prevention layer BCF, a red wavelength conversion layer WCR, a green wavelength conversion layer WCG, a light source light scattering layer SL, a red excitation light absorbing layer EXR, and a green excitation light absorbing layer EXG are arranged into a stripe pattern. The stray light prevention layer BCF, the red wavelength conversion layer WCR, and the red excitation light absorbing layer EXR corresponding to the red pixel are laminated adjacently to the liquid crystal layer LC in this order. Likewise, the stray light prevention layer BCF, the green wavelength conversion layer WCG and the green excitation light absorbing layer EXG corresponding to the green pixel are laminated adjacently to the liquid crystal layer LC in this order. The light source light scattering layer SL corresponds to the blue pixel. The laminate of the stray light prevention layer BCF, the red wavelength conversion layer WCR, and the red excitation light absorbing layer EXR, the laminate of the stray light prevention layer BCF, the green wavelength conversion layer WCG and the green excitation light absorbing layer EXG, and the light source light scattering layer SL are partitioned from one another with light extraction structures LDSs, respectively. The light extraction structure LDS includes a wall-like structure WL and a reflection layer RF. The wall-like structure WL protrudes upward from the first substrate SU1, and the reflection layer RF is distributed on the wall surface of the light extraction structure LDS. FIGS. 16A and 16B illustrate examples of the wall-like structure WL of the light extraction structure LDS. FIG. 16A represents an example that the walls of the wall-like structure WL take the stripe pattern. FIG. 16B represents an example that the walls of the wall-like structure WL take the waffle pattern. In the embodiment having the wall-like structure of stripe pattern has the wall thickness set to 7 μm, the wall height set to 30 μm, and the wall pitch set to 40 μm. In the embodiment having the wall-like structure of waffle pattern has the wall thickness set to 7 μm, the wall height set to 30 μm, the wall pitch at short side set to 40 μm, and the wall pitch at long side set to 120 μm.

A second orientation film AL2, a source electrode SE, a first insulating film IL1, a second insulating film IL2, a signal wiring DL, a third insulating film IL3, a scanning wiring, a polysilicon layer, and an undercoat film UC are provided on the second substrate SU2 from the side adjacent to the liquid crystal layer LC in this order.

The source electrode SE and the second common electrode are laminated via the first insulating film IL1, which constitute a storage capacitor for holding the potential of the liquid crystal layer LC constant during the holding period. The source electrode SE is connected to the signal wiring DL via the polysilicon layer PS and the contact hole so that the potential in accordance with the image signal is applied to the liquid crystal layer LC. As the scanning wiring, the polysilicon layer, the second common electrode and the contact hole are not shown in FIG. 1 as they are not contained in the cross section.

The liquid crystal layer LC has positive dielectric constant anisotropy having the dielectric constant in the orientation direction larger than the one in the direction perpendicular thereto, which exhibits the nematic phase with high resistance in the broad temperature range including the room temperature. The orientation state of the liquid crystal layer LC in the non-voltage application state shows the homogeneous orientation while being twisted at 90°. FIG. 1 schematically shows the orientation state in reference to the cylindrical liquid crystal molecules LCM. The common electrode CE and the source electrode SE are disposed as shown in FIG. 1 so that the electric field parallel to the layer thickness direction is applied to the liquid crystal layer LC. This changes the orientation state of the liquid crystal layer LC to increase the tilt angle.

A polarizing plate PL is disposed as the lower layer of the second substrate SU2 so that absorption axes of the polarizing plate PL and the polarizing layer WGP formed on the first substrate orthogonally intersect when observed from the normal direction of the liquid crystal panel. The absorption axes of the polarizing plate PL and the polarizing layer WGP orthogonally intersect with respect to the orientation direction adjacent to the liquid crystal layer LC. The incident light onto the liquid crystal layer in the non-voltage application state has its vibration direction parallel to the liquid crystal orientation direction. The light then passes through the polarizing layer WGP with high efficiency while having the vibration direction rotated at 90° in the liquid crystal layer.

A light source LS and a light guide plate LG are disposed below the second substrate SU2. A blue LED (Light Emitting Diode) which emits the light with wavelength of approximately 470 nm is disposed as the light source LS on the side surface of the light guide plate LG. The light from the blue LED is planarly expanded by the light guide plate LG, and is directed toward the perpendicular direction of the liquid crystal panel. The wavelength of the light passing through the liquid crystal layer is limited to the value of approximately 470 nm. Therefore, the value Δnd of the liquid crystal layer LC is set to approximately 350 nm so that the vibration direction of the light with the wavelength of 470 nm is rotated at 90° in the non voltage application state. The liquid crystal layer LC functions as an optical shutter that adjusts the intensity of the light source light, which is incident onto the red wavelength conversion layer WCR and the green wavelength conversion layer WCG. The function of the optical shutter may be derived not only from the liquid crystal layer LC but also the MEMS (Micro Electro Mechanical Systems) and ECD (Electro Chromic Display), for example. Moreover the longitudinal field system, the transverse field system may be employed for changing direction of the liquid crystal molecules.

The polarizing layer WGP is a stripe-patterned metallic film, and has a function that selectively transmits the polarized component having the vibration directed perpendicularly with respect to the stripe. The repeating pitch of the stripe structure is set to 100 nm or smaller. More preferably, the repeating pitch of the stripe structure is set to 50 nm or smaller so as to provide the transmittance equivalent to that of the generally employed polarizing plate or higher with respect to the light with wavelength of 470 nm. The generally employed polarizing plate of pigment system is produced by drawing the polyvinyl alcohol to which iodine is added.

The light source light, passing through the polarizing layer WGP partially becomes incident light onto the light source light scattering layer SL, and the blue light having the wavelength unconverted is irradiated from the first substrate SU1. The light source light scattering layer SL is made of the transparent film having microparticles with high refractive index dispersed. The angular distribution is imparted to the highly collimating light source light through refraction on the surface of the microparticle. The microparticle size, the refractive index, and the mixture ratio are adjusted so that the angular distribution of the scattered light is equal to the angular distribution of the red and green fluorescent lights generated in the red wavelength conversion layer WCR and the green wavelength conversion layer WCG, respectively.

The light source light, which has passed through the polarizing layer WGP partially becomes incident light onto the red wavelength conversion layer WCR and the green wavelength conversion layer WCG. Both the red wavelength conversion layer WCR and the green wavelength conversion layer WCG contain organic or inorganic fluorophors. Those fluorophors absorb the light source light of blue for emitting the red and the green fluorescent light. Therefore, the light source light is subjected to the wavelength conversion to the red light and green light. More specifically, they are absorbed by the red and green fluorescent pigments respectively contained in the red wavelength conversion layer WCR and the green wavelength conversion layer WCG so as to generate the red and green fluorescent lights.

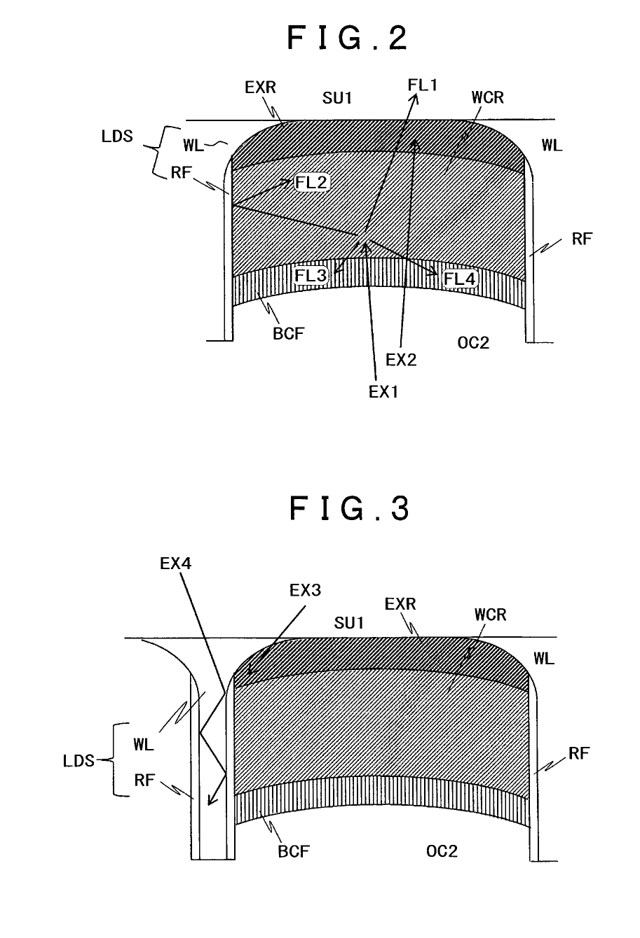

FIG. 2 is an enlarged view of the laminate corresponding to the red pixel, taking the typical optical path of the fluorescent light corresponding to the red pixel as an example. The isotropically emitted fluorescent light generates the fluorescent components FL3 and FL4 toward the second substrate SU2. If they are returned to the second substrate SU2 and reflected by the signal wiring DL and the like to enter into the other pixel, the display performance may be undesirably deteriorated. The stray light prevention layer BCF is made of the blue color filter for absorbing the light except the blue light. The stray light prevention layer BCF serves to transmit the light source light EX1 or EX2, and to absorb components of the red fluorescent light generated in the red wavelength conversion layer WCR and the green fluorescent light generated in the green wavelength conversion layer WCG, which are returned to the second substrate SU2. This makes it possible to prevent deterioration in the display performance through absorption of the fluorescent components FL3 and FL4.

The red wavelength conversion layer WCR and the green wavelength conversion layer WCG are required to allow emission on the proximity surface with respect to the second substrate SU2 for highly efficient emission. If the light source light is radiated from the first substrate SU1 without being completely absorbed by the red wavelength conversion layer WCR and the green wavelength conversion layer WCG, the light source light of blue is mixed with the red and green fluorescent lights to deteriorate the color purity. This is not preferable as it leads to change in the color phase. The red excitation light absorbing layer EXR and the green excitation light absorbing layer EXG are respectively made of the red color filter and the yellow color filters, which allow passage of the red and green fluorescent lights, but absorbs the blue light source light EX2 as FIG. 2 shows. Although the green color filter may be used, it is less practical because of Gaussian function feature. The red excitation light absorbing layer EXR and the green excitation light absorbing layer EXG allow prevention of deterioration in the color purity and change in the color phase owing to mixture of the light source light while enhancing the light emitting efficiency of the red wavelength conversion layer WCR and the green wavelength conversion layer WCG.

The blue light with the same wavelength as that of the light source light is contained in the illumination light and sunlight. Upon incidence of the blue light onto the red wavelength conversion layer WCR and the green wavelength conversion layer WCG, the red and green fluorophors emit the red and green fluorescent lights to undesirably deteriorate the contrast ratio and the color purity. The red excitation light absorbing layer EXR and the green excitation light absorbing layer EXG absorb the blue light contained in the external incident light so as to prevent incidence of such light onto the red wavelength conversion layer WCR and the green wavelength conversion layer WCG. FIG. 3 is an enlarged view of the laminate corresponding to the red pixel, showing the typical optical path of the external incident blue light. The reflection layer RF is perpendicular to the normal of the first substrate SU1, having the red excitation light absorbing layer EXR on one side surface and the wall-like structure WL on the other side surface. The blue light EX3 incident from the red excitation light absorbing layer EXR is absorbed thereby so as not to reach the reflection layer RF. The blue light EX4 incident from the wall-like structure WL is not directly incident onto the red wavelength conversion layer WCR. The resultant influence, thus, is thought to be relatively small.

The red and green fluorescent lights are generated and emitted isotropically by the red wavelength conversion layer WCR and the green wavelength conversion layer WCG, both of which distribute in the region of the light extraction structure LDS. The small fluorescent light component indicated as the fluorescent component FL1 in FIG. 2 is directly radiated from the first substrate SU1. A major part of the red and green fluorescent lights is incident onto the reflection layer RF on the wall surface of the light extraction structure LDS as indicated by the fluorescent component FL2 shown in FIG. 2. The light is reflected once or a plurality of times, and then radiated from the first substrate SU′. If there is no light extraction structure LDS, most part of the red and green fluorescent lights enters into the adjacent red wavelength conversion layer WCR, the green wavelength conversion layer WCG or the light source light scattering layer SL. It is then absorbed and emitted again, or scattered to change the direction so as to be radiated from the first substrate SU1. Alternatively, it is directed toward the second substrate SU2, thus deteriorating the display performance. The light extraction structure LDS suppresses the deterioration in the display performance by preventing generation of the stray light, and exhibits the effect for improving the external extraction efficiency.

The wall-like structure WL of the light extraction structure LDS protruding upward from the first substrate includes a proximal portion with small inclination angle (splay shape) and a wall surface with the inclination angle nearly 90° (perpendicular shape). The reflection layer RF is distributed only on the wall surface at the inclination angle nearly 90°. The red excitation light absorbing layer EXR and the green excitation light absorbing layer EXG are distributed adjacently to the proximal portion with small inclination angle, closer to the first substrate SU1 than the reflection layer RF. Most part of the external incident light directed to the reflection layer RF may be absorbed by the red excitation light absorbing layer EXR and the green excitation light absorbing layer EXG. Use of the display device of the embodiment is unlikely to deteriorate the contrast ratio resulting from reflection of the external light by the reflection layer RF.

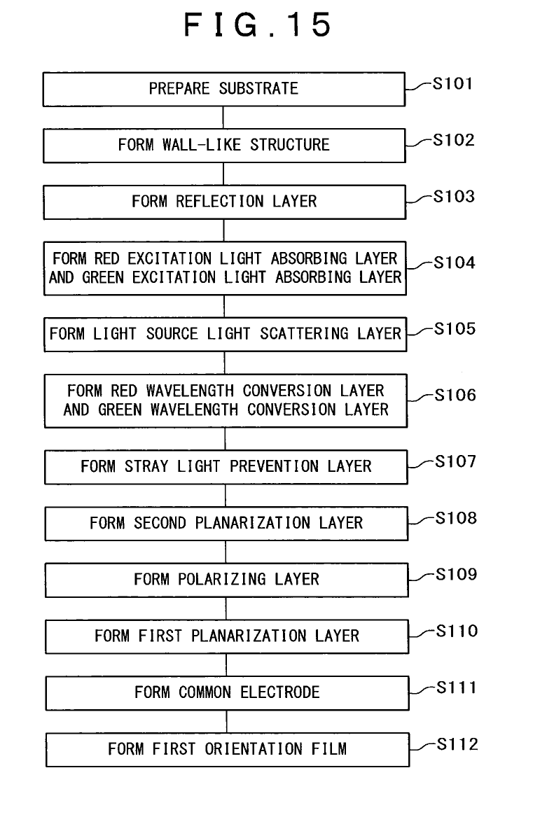

An example of the method of manufacturing the first substrate (referred to as a wavelength converting substrate) of the display device, on which the wavelength conversion layer and the like are mounted will be described referring to FIG. 15. FIG. 15 is an exemplary flowchart of the process steps of manufacturing the wavelength converting substrate. The flow may be changed depending on the structure of the TFT substrate formed as the counter substrate. The substrate (first substrate) is prepared in step S101. The glass substrate is employed in this case. However, any material may be used for forming the substrate so long as it transmits the red light, green light, blue light and ultraviolet radiation.

The wall-like structure is formed in step S102. The wall-like structure WL is formed through the photolithography process including application, exposure, development and burning of the highly transparent negative resist. At this time, the proximal portion with small inclination angle (splay shape) and the wall surface with inclination angle nearly 90° (perpendicular shape) are formed by adjusting the amount of exposure and the development conditions. The negative resist exhibits sufficiently high transparency, which allows the proximal portion with small inclination angle to cover the entire surface of the first substrate SU1.

Then the reflection layer is formed in step S103. The reflection layer RF is formed through the process steps of cleaning the first substrate SU1 on which the wall-like structure WL is formed, forming a metallic film on the wall-like structure WL through sputtering to allow etching gas to be incident from the substrate normal direction so as to leave the metallic film only on the wall surface with the inclination angle nearly 90° which is less in contact with the etching gas (anisotropic etching). The metallic film may be formed by vapor deposition instead of sputtering. It is possible to use aluminum, silver and the alloy which contains the aforementioned metal as the main component for forming the reflection layer.

The red excitation light absorbing layer and the green excitation light absorbing layer are formed in step S104. The red excitation light absorbing layer EXR and the green excitation light absorbing layer EXG are simultaneously formed (in the same step) by dropping red ink and green ink to predetermined regions on the wall-like structure WL through two nozzles, respectively (red ink is dropped to the region corresponding to the red pixel, and the green ink is dropped to the region corresponding to the green pixel), and removing the solvent. It is possible to employ well-known red ink and green ink.

The light source light scattering layer SL is formed in step S105. The light source light scattering layer SL is formed by performing screen printing of the transparent light scattering layer in which microparticles with high refractive index are dispersed on the predetermined region (corresponding to the blue pixel) on the wall-like structure WL, and removing the solvent.

The red wavelength conversion layer WCR and the green wavelength conversion layer WCG are formed in step S106. The red wavelength conversion layer WCR and the green wavelength conversion layer WCG are simultaneously formed (in the same step) by dropping the red fluorescent ink and the green fluorescent ink to the predetermined regions on the wall-like structure WL through two nozzles, (the red fluorescent ink is dropped to the region corresponding to the red pixel, and the green fluorescent ink is dropped to the region corresponding to the green pixel), and removing the solvent. It is possible to employ the well-known red fluorescent ink and green fluorescent ink.

The stray light prevention layer BCF is formed in step S107. The stray light prevention layer is formed by dropping the blue ink to the predetermined regions on the wall-like structure WL (region corresponding to the red pixel and the region corresponding to the green pixel), and removing the solvent. It is possible to employ a well-known blue ink.

The second planarization layer OC2 is formed in step S108. The second planarization layer OC2 is formed through the process steps of cleaning the first substrate SU1 on which a stray light prevention layer BCF is formed, applying the transparent resist, removing the solvent in the resist, performing exposure of entire surface, and burning. It is possible to employ the organic material such as polyimide and acrylic resin besides the resist as the material for forming the planarization layer.

The polarizing layer WGP is formed in step S109. The polarizing layer WGP is formed by cleaning the first substrate SU1 on which the second planarization layer OC2 is formed, and performing the polarization layer offset printing.

Then the first planarization layer OC1 is formed in step S110. The first planarization layer OC1 is formed through the process steps of applying the transparent resist onto the first substrate SU1 on which the polarizing layer WGP is formed, removing the solvent in the resist, performing the entire surface exposure, and burning. It is possible to employ the organic material such as polyimide and acrylic resin besides the resist as the material for forming the planarization layer.

The common electrode CE is formed in step S111. The common electrode CE is formed through the process steps of cleaning the first substrate SU1 on which the first planarization layer OC1 is formed, forming the ITO film through sputtering, and burning. It is possible to employ IZO (Indium Zinc Oxide) as the material for forming the common electrode besides the ITO (Indium Tin Oxide).

The first orientation film AL1 is formed in step S112. The first orientation film AL1 is formed through the orientation process steps of printing the orientation film on the first substrate SU1 on which the common electrode CE is formed, removing the solvent in the orientation film, burning, and rubbing.

The wavelength converting substrate is manufactured by performing the aforementioned steps. According to the method, the red excitation light absorbing layer EXR, the green excitation light absorbing layer EXG, the red wavelength conversion layer WCR, the green wavelength conversion layer WCG, and the light scattering layer SR are formed subsequent to formation of the light extraction structure LDS. It is possible to use the method with higher efficiency than the photolithography, for example, the ink jet process and the screen printing process for forming those layers. In other words, the ink with fluidity will spread after application, resulting in disadvantages of low positioning accuracy of patterning and relatively large minimum processing dimension. The embodiment uses the light extraction structure LDS formed through the photolithography as the threshold that prevents the ink from spreading owing to fluidity. This makes it possible to apply the ink jet process and the screen printing process as the highly efficient method which can be performed at high speeds, requiring less process steps. The excitation light absorbing layer, the wavelength conversion layer and the like which are formed in the region partitioned by the walls of the wall-like structure are not required to be subjected to the photolithography patterning. This makes it possible to use non-photopolymerizable ink and realize easy handling of the ink with no need of considering influence of the light. The embodiment allows the patterning with the accuracy substantially equivalent to that of the photolithography while keeping the ink jet process and the screen printing process highly efficient. The embodiment also provides the effect of increasing the production volume and reducing the cost.

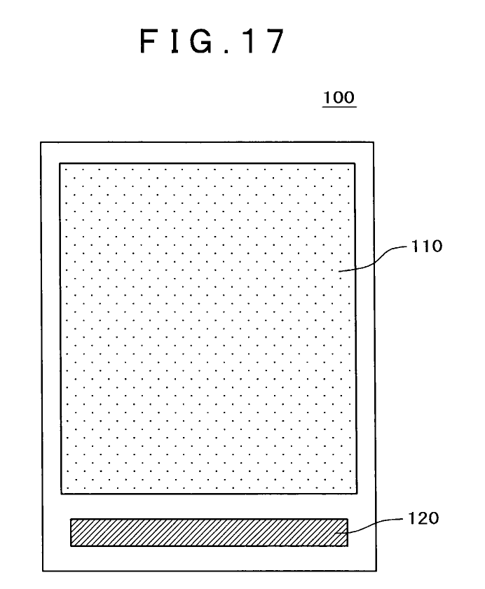

The wavelength converting substrate and the TFT substrate manufactured through the generally employed process are bonded while interposing the liquid crystal, which are combined with the light source. This makes it possible to provide the display device (liquid crystal display device). FIG. 17 shows an example of a display device 100 as well as a display region 110 and a drive circuit section 120. As a result of evaluating the display device, deterioration in image quality, for example, reduction in the contrast ratio may be suppressed even if the device is used under the environment with much external light like outdoor in the daytime. As high efficiency for light utilization reduces the power consumption (except the drive circuit section) to substantially half, the device is suitably applied as the display device for the mobile unit which is driven by the battery. The fluorophor LCD is allowed to have the wide viewing angle using isotropy of fluorescent emission. This may eliminate the need of considering the viewing angle property in the liquid crystal display mode. It is therefore possible to apply various types of longitudinal field systems more advantageous to the incidental image property than the IPS type. It is therefore suitable to be applied to the medical monitoring device required to provide better incidental image.

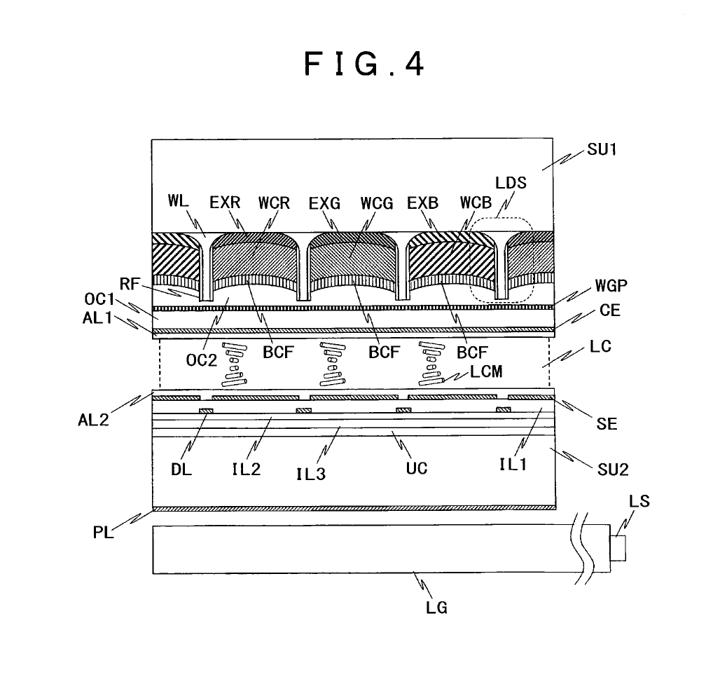

In the embodiment which employs the blue light source, and the light source light scattering layer is used for the part corresponding to the blue pixel. However, it is possible to use the light source light with the near ultraviolet wavelength, and display the blue color with fluorescent light. In such a case, as FIG. 4 shows, the blue wavelength conversion layer WCB, the blue excitation light absorbing layer EXB and the stray light prevention layer BCF may be laminated instead of using the light source light scattering layer SL shown in FIG. 1. The stray light prevention layer BCF becomes the color filter that passes the near-ultraviolet light but passes no visible light. In this case, all the light of red, green and blue will become fluorescent. This enables to easily make each angular distribution of the respective colors uniform.

According to the present invention, the excitation light absorbing layer is laminated on the wavelength conversion layer at the external light side so as to allow provision of the display device with high brightness and high image quality even in the outdoor environment. The excitation light absorbing layer passes the fluorescent light but absorbs the light source light. It is therefore possible to prevent deterioration in the color purity and change in the color phase owing to mixture of the light source light while enhancing emission efficiency of the wavelength conversion layer. The stray light prevention layer is provided on the wavelength conversion layer at the light source side so as to pass the light source light but absorbs the component of the fluorescent light generated in the wavelength conversion layer, which returns to the second substrate SU2. It is therefore possible to prevent deterioration in the display performance.

### Second Embodiment

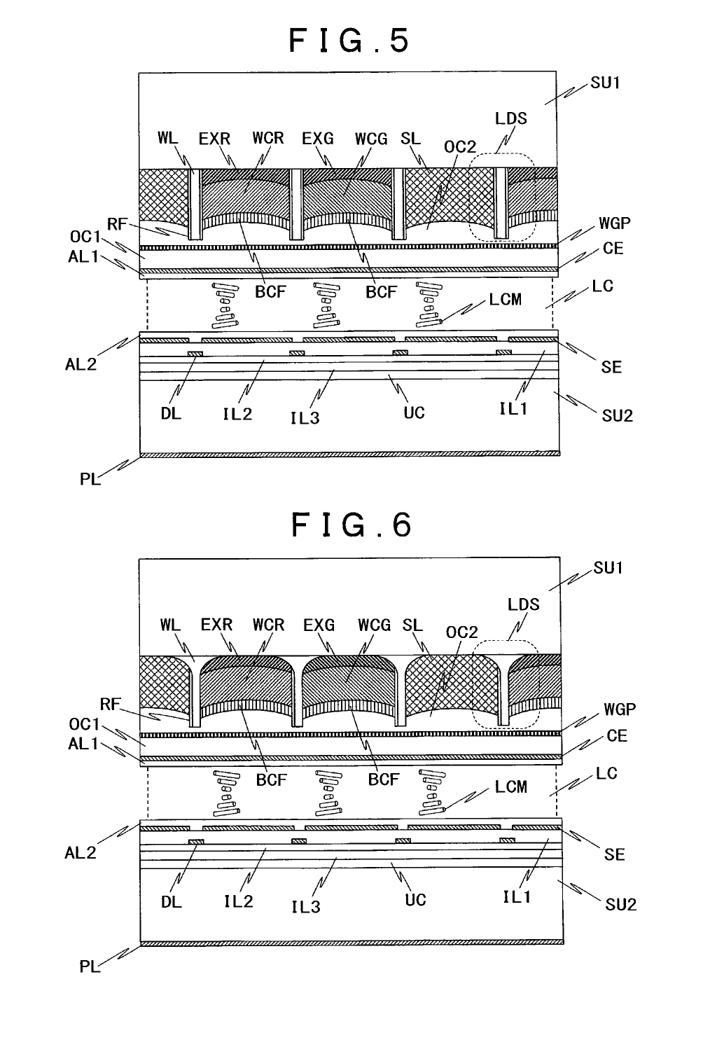

A display device of a second embodiment according to the present invention will be described referring to FIG. 5. The description which has been explained in the first embodiment may be applied to this embodiment unless otherwise special circumstances, and explanation thereof, thus will be omitted. FIG. 5 is a sectional view of a main part of the display device of the embodiment. This embodiment is different from the first embodiment in that the proximal portion (splay shape) with small inclination angle is removed from the wall-like structure WL of the light extraction structure LDS to provide only the wall surface (perpendicular shape) with the inclination angle nearly 90° as shown in FIG. 5. The cross-section of the wall-like structure WL may be obtained by selecting the highly reactive negative resist material, and adjusting the amount of exposure and development conditions for subjecting the material to the photolithography process of the material. In this embodiment, the organic negative resist of self-amplifying type is used for forming the highly reactive resist material. The exposure condition sets the illuminance to 170 mJ/cm², and the irradiation time to 50 seconds using string-G & string-G. The development condition sets the temperature to 100° and the developing time to 10 minutes using the organic alkaline developing agent. The display device according to this embodiment is inferior to that of the first embodiment with respect to structural stability. However, the wide distribution range of the reflection layer RF allows higher light extraction efficiency.

The above-structured wavelength converting substrate and the TFT substrate manufactured through the generally employed process are bonded while interposing the liquid crystal, which are combined with the light source to provide the display device (liquid crystal display device). As a result of evaluating the display device, deterioration in image quality, for example, reduction in the contrast ratio may be suppressed even if the device is used under the environment with much external light like outdoor in the daytime.

According to the embodiment, the excitation light absorbing layer is laminated on the wavelength conversion layer at the external light side so as to allow provision of the display device with high brightness and high image quality even in the outdoor environment. The wall-like structure WL is made to have only wall surface at the angle nearly 90°, resulting in higher light extraction efficiency.

### Third Embodiment

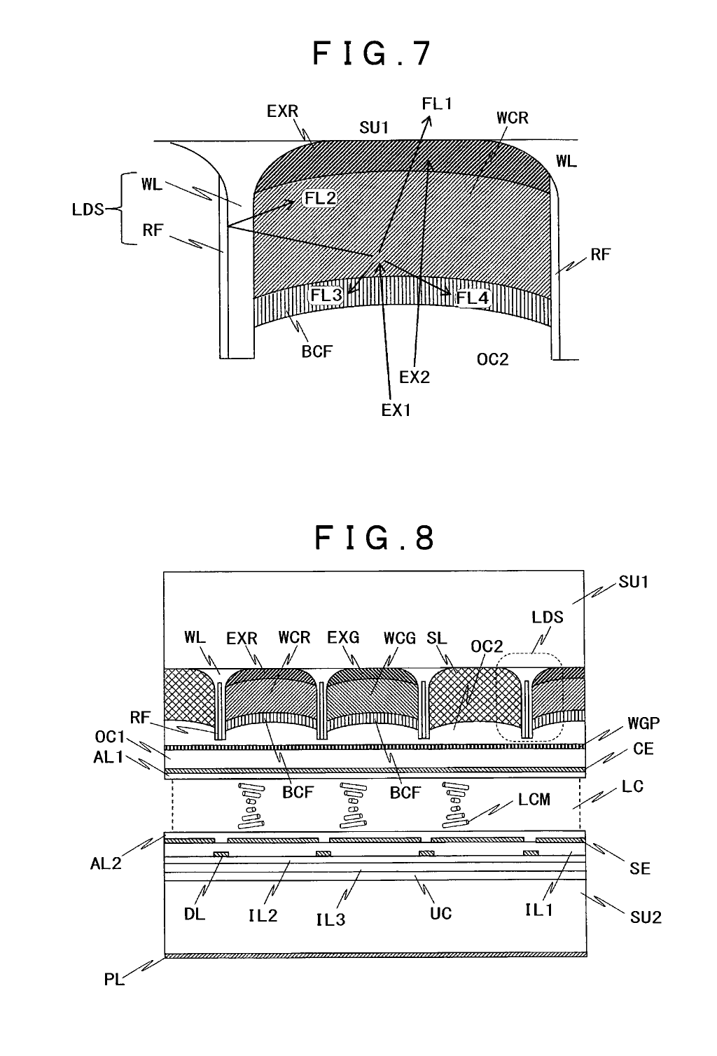

A display device of a third embodiment according to the present invention will be described referring to FIGS. 6 and 7. The description which has been explained in the first or the second embodiment may be applied to this embodiment unless otherwise special circumstances, and explanation thereof, thus will be omitted. FIG. 6 is a sectional view of a main part of the display device of the embodiment. This embodiment is different from the first embodiment in that the reflection layer RF in the light extraction structure LDS is formed only on one side of the wall-like structure WL as shown in FIG. 6. The structure may be obtained after forming the reflection layer RF in the light extraction structure LDS on both sides of the wall-like structure WL by covering only one side with the resist pattern, and removing the other side through etching.

FIG. 7 shows the typical optical path of the fluorescent light generated by the display device according to the embodiment. As the wall-like structure WL is transparent, the fluorescent component FL2 passes through the wall-like structure WL, and is reflected by the adjacent reflection layer RF, for example, the one adjacent to the green wavelength conversion layer WCG corresponding to the green pixel. It is then allowed to pass through the wall-like structure WL again. As a result, the similar optical path to the one described in the first embodiment shown in FIG. 2 is realized, providing the efficiency improving effect likewise the first embodiment.

The structure with high aspect ratio such as the wall-like structure WL is obtained by forming the thick film of the negative resist with high sensitivity so as to be photo-polymerized. The high sensitivity of the negative resist is derived from easy passage of the light in the film thickness direction for causing the polymerization reaction. The wall-like structure WL inevitably exhibits the high transmittance.

Referring to FIG. 6, the respective reflection layers RF are formed on the same side surface of the wall-like structure WL. The method of forming the reflection layer RF is not limited to the one for forming the reflection layers RF only on one side of the wall-like structure WL. They may be formed on different side surfaces, respectively. In any of the cases, the wall-like structure WL is sufficiently thin and transparent, thus providing the similar efficiency improving effect to the one derived from the first embodiment.

The above-structured wavelength converting substrate and the TFT substrate manufactured through the generally employed process are bonded while interposing the liquid crystal, which are combined with the light source to provide the display device (liquid crystal display device). As a result of evaluating the display device, deterioration in image quality, for example, reduction in the contrast ratio may be suppressed even if the device is used under the environment with much external light like outdoor in the daytime.

According to the embodiment, the excitation light absorbing layer is laminated on the wavelength conversion layer at the external light side so as to allow provision of the display device with high brightness and high image quality even in the outdoor environment. In the case where the reflection layers are disposed only on one side of the wall-like structure, the similar light extraction efficiency to the one obtained when those layers are disposed on both sides.

### Fourth Embodiment

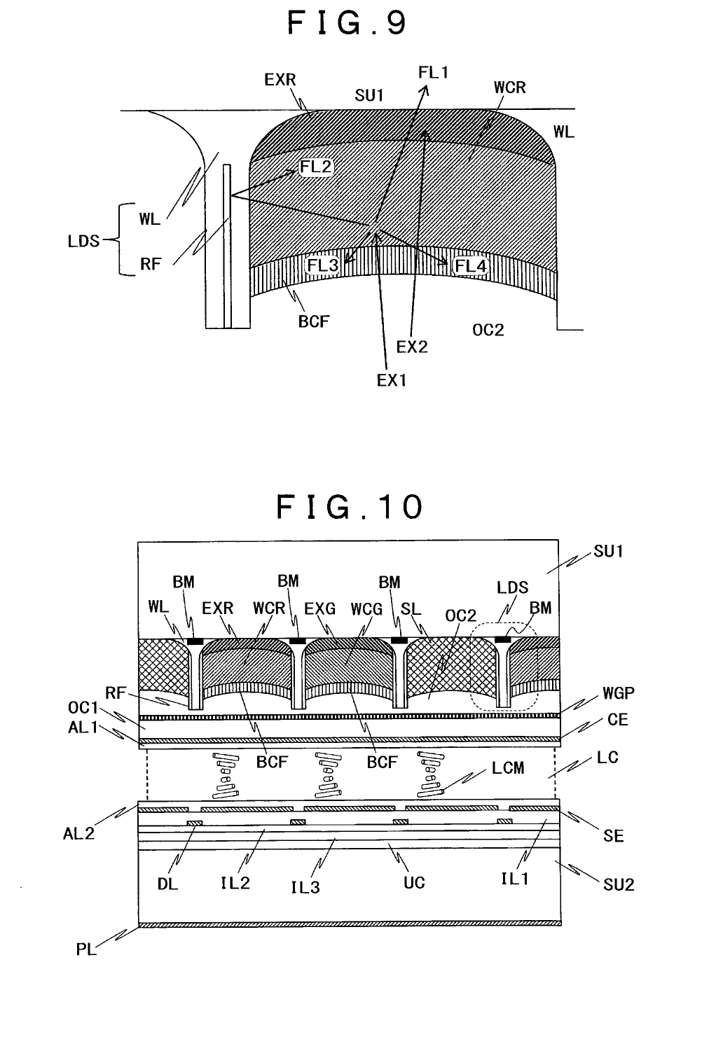

A display device of a fourth embodiment according to the present invention will be described referring to FIGS. 8 and 9. The description which has been explained in the first or the second embodiment may be applied to this embodiment unless otherwise special circumstances, and explanation thereof, thus will be omitted. FIG. 8 is a sectional view of a main part of the display device of the embodiment. This embodiment is different from the first embodiment in that the reflection layer RF of the light extraction structure LDS is located inside the wall-like structure WL. FIG. 9 shows a typical optical path of the fluorescent light generated in the display device of the embodiment. As the wall-like structure WL is transparent, the fluorescent component FL2 passes through approximately half the wall width of the wall-like structure WL to be reflected by the reflection layer RF, and passes through the approximately half the wall width of the wall-like structure WL again. This realizes the optical path similar to that of the first embodiment shown in FIG. 2, and provides the similar efficiency to the one derived from the first embodiment.

The reflection layer RF is formed only on one side of the wall-like structure WL as shown in FIG. 7, and then the upper part of the reflection layer RF is covered with the negative resist so that the reflection layer RF is formed inside the wall-like structure WL. If silver or the silver alloy is used for forming the reflection layer RF, the resultant reflection layer may possibly be oxidized in the high-temperature and high-humidity environment of the subsequent process, leading to reduced reflectance. As the embodiment is configured to locate the reflection layer RF inside the wall-like structure WL, reflectance reduction may be avoided.

The above-structured wavelength converting substrate and the TFT substrate manufactured through the generally employed process are bonded while interposing the liquid crystal, which are combined with the light source to provide the display device (liquid crystal display device). As a result of evaluating the display device, deterioration in image quality, for example, reduction in the contrast ratio may be suppressed even if the device is used under the environment with much external light like outdoor in the daytime.

According to the embodiment, the excitation light absorbing layer is laminated on the wavelength conversion layer at the external light side so as to allow provision of the display device with high brightness and high image quality even in the outdoor environment. Arrangement of the reflection layers inside the wall-like structure makes it possible to suppress reflectance deterioration under the high-temperature and high-humidity environment in the subsequent process.

### Fifth Embodiment

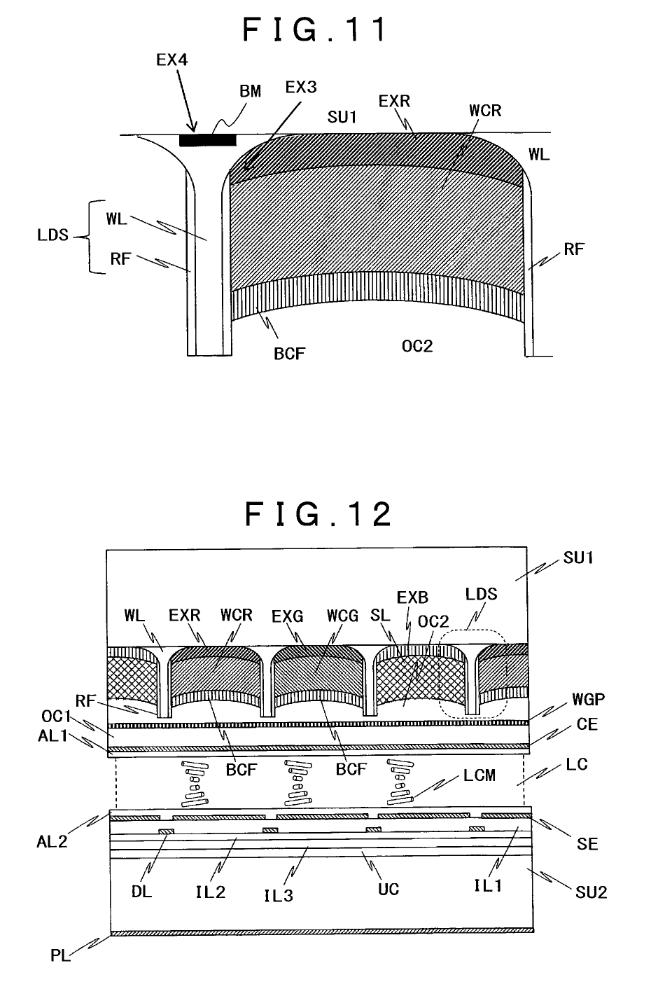

A display device of a fifth embodiment according to the present invention will be described referring to FIGS. 10 and 11. The description which has been explained in any of the first to the fourth embodiments may be applied to this embodiment unless otherwise special circumstances, and explanation thereof, thus will be omitted. FIG. 10 is a sectional view of a main part of the display device of the embodiment. This embodiment is different from the first embodiment in that a black matrix BM is formed between the first substrate SU1 and the light extraction structure LDS. The black matrix BM contains a black pigment, and absorbs the light with entire visible wavelength. Distribution of the black matrix BM corresponds to the distribution of the light extraction structure LDS, which superposes the reflection layer RF of the light extraction structure LDS from the view in the substrate normal direction.

FIG. 11 is an enlarged view of the laminate corresponding to the red pixel, indicating the typical optical path of a blue light EX4 as external incident light. The reflection layer RF is perpendicular to the normal of the first substrate SU1, having a red excitation light absorbing layer EXR on one surface, and the wall-like structure WL on the other surface. The blue light EX3 incident from the red excitation light absorbing layer EXR is absorbed thereby, and is not allowed to reach the reflection layer RF. The blue light EX4 incident from the wall-like structure WL is absorbed by the black matrix BM, and is not allowed to reach the reflection layer RF.

The black matrix BM is provided for shielding purpose in addition to the red excitation light absorbing layer EXR and the green excitation light absorbing layer EXG according to the first embodiment. This makes it possible to absorb more external light directed to the reflection layer RF as clearly shown in comparison with FIG. 3. This structure is capable of suppressing deterioration in the display performance owing to reflection of the external light by the reflection layer RF further completely. This may suppress deterioration in the image quality, for example, reduction in the contrast ratio even if the device is used under the environment with much external light like outdoor in the daytime.

The above-structured wavelength converting substrate and the TFT substrate manufactured through the generally employed process are bonded while interposing the liquid crystal, which are combined with the light source to provide the display device (liquid crystal display device). As a result of evaluating the display device, deterioration in image quality, for example, reduction in the contrast ratio may be suppressed even if the device is used under the environment with much external light like outdoor in the daytime.

According to the embodiment, the excitation light absorbing layer is laminated on the wavelength conversion layer at the external light side so as to allow provision of the display device with high brightness and high image quality even in the outdoor environment. Arrangement of the black matrix BM between the first substrate SU1 and the light extraction structure LDS makes it possible to further suppress image quality deterioration.

### Sixth Embodiment

A display device of a sixth embodiment according to the present invention will be described referring to FIG. 12. The description which has been explained in any of the first to fifth embodiments may be applied to this embodiment unless otherwise special circumstances, and explanation thereof, thus will be omitted. FIG. 12 is a sectional view of a main part of the display device of the embodiment. This embodiment is different from the first embodiment in that the blue excitation light absorbing layer EXB is formed between the light source light scattering layer SL and the first substrate SU1 as shown in FIG. 12. The blue excitation light absorbing layer EXB includes a blue color filter which allows passage of the blue light source light but absorbs the visible light with any other wavelength.

A part of the external light incident onto the light source light scattering layer SL reaches the reflection layer RF which may reflect the light to be directed to the second substrate SU2. If the light is reflected by the source wiring SE or the like to be directed to the other pixel, there is the possibility of deteriorating the display performance. The embodiment is configured to absorb the visible light component other than the blue light. Therefore, deterioration in image quality, for example, reduction in the contrast ratio may be suppressed even if the device is used under the environment with much external light like outdoor in the daytime.

In this embodiment, the blue excitation light absorbing layer EXB is added to the display device according to the first embodiment. The blue excitation light absorbing layer EXB is formed after formation of the light extraction structure LDS. This allows the use of such method as the ink jet process and the screen printing process for forming the layer. Addition of a new layer will not impose so much burden on the manufacturing process.

The above-structured wavelength converting substrate and the TFT substrate manufactured through the generally employed process are bonded while interposing the liquid crystal, which are combined with the light source to provide the display device (liquid crystal device). As a result of evaluating the display device, deterioration in image quality, for example, reduction in the contrast ratio may be suppressed even if the device is used under the environment with much external light like outdoor in the daytime.

According to the embodiment, the excitation light absorbing layer is laminated on the wavelength conversion layer at the external light side so as to allow provision of the display device with high brightness and high image quality even in the outdoor environment. Arrangement of the blue excitation light absorbing layer between the light source light scattering layer and the first substrate absorbs the visible light component other than blue color from the blue pixel. This makes it possible to further suppress the image quality deterioration.

### Seventh Embodiment

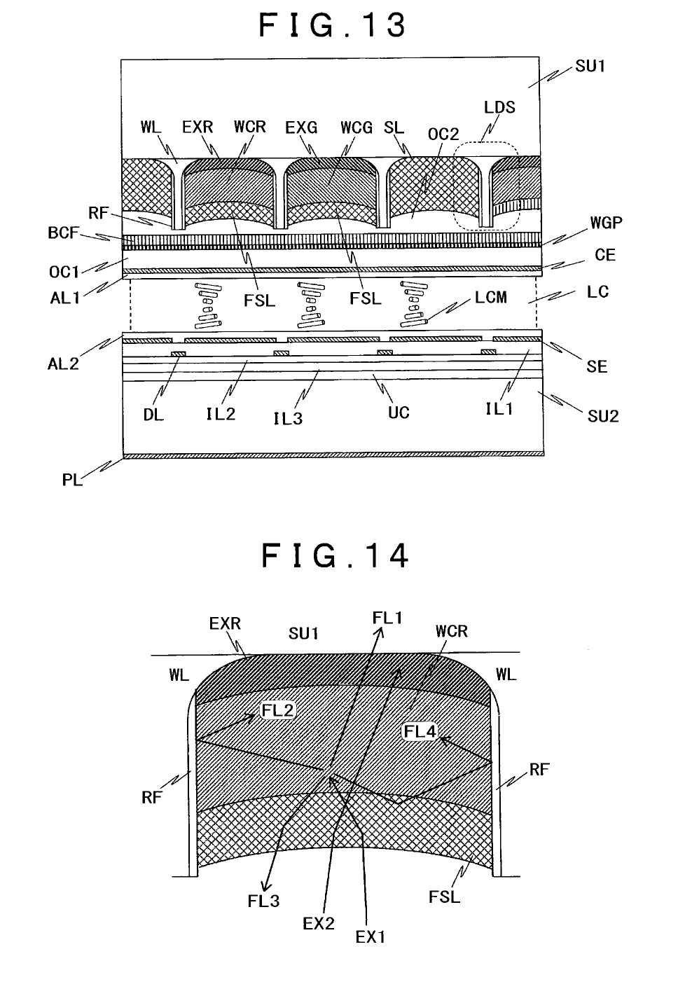

A display device of a seventh embodiment according to the present invention will be described referring to FIGS. 13 and 14. The description which has been explained in any of the first to sixth embodiments may be applied to this embodiment unless otherwise special circumstances, and explanation thereof, thus will be omitted. FIG. 13 is a sectional view of a main part of the display device of the embodiment. This embodiment is different from the first embodiment in that a fluorescent scattering layer FSL is disposed on the red wavelength conversion layer WCR and the green wavelength conversion layer WCG at the side of the liquid crystal layer LC as shown in FIG. 13. The fluorescent scattering layer FSL is made of a transparent film with dispersed high reflectance microparticles, from which the forward scattering is mainly observed.

FIG. 14 is an enlarged view of the laminate corresponding to the red pixel, indicating the typical optical path of the light source light and the fluorescent light. The light source lights EX1 and EX2 are incident onto the fluorescent scattering layer FSL before they reach the red wavelength conversion layer WCR. Each of the light source lights EX1 and EX2 is incident onto the fluorescent scattering layer FSL mainly from the normal direction of the first substrate SU1 because of high collimating property. The fluorescent scattering layer FSL mainly exhibits the forward scattering so that the light source lights EX1 and EX2 are incident onto the red wavelength conversion layer WCR from the direction more inclined than the case shown in FIG. 2 with respect to the normal direction of the first substrate SU1. Referring to FIG. 14, the light source lights EX1 and EX2 are both incident onto the red wavelength conversion layer WCR at the light intensity with substantially no noticeable difference from the first embodiment. Each intensity of the red and green fluorescent lights is the same as that of the display device according to the first embodiment.

The isotropic propagation of the red fluorescent light generates components FL1 and FL2 directed to the first substrate SU1 as shown in FIG. 14. The obtained optical path is also similar to the one as described in the first embodiment. The fluorescent components FL3 and FL4 directed to the second substrate SU2 are also generated. They are incident onto the fluorescent scattering layer FSL after emission from the red wavelength conversion layer WCR. As described above, the fluorescent scattering layer FSL mainly exhibits the forward scattering. The fluorescent component FL4 incident at the large angle with respect to the normal direction of the plane of the fluorescent scattering layer FSL among those of FL3 and FL4 is scattered in the fluorescent scattering layer FSL. The resultant component in the substrate normal direction along the progressing direction is changed in the direction from the second substrate SU2 to the first substrate SU1. The reflection layer RF of the light extraction structure LDS reflects repeatedly for emission from the first substrate SU1. Both the fluorescent components FL3 and FL4 are directed to the second substrate SU2 as shown in FIG. 2. FIG. 14 shows emission of the fluorescent light component FL4 from the first substrate SU1, and the intensity of the red fluorescent light directed to the first substrate SU1 is increased to enhance the external quantum efficiency. This applies to the green fluorescent light, thus enhancing the external quantum efficiency of the green fluorescent light as well.

In this embodiment, the fluorescent scattering layer FSL is added to the display device of the first embodiment. The method such as the ink jet process and the screen printing process may be used for forming the fluorescent scattering layer FSL as it can be formed after formation of the light extraction structure LDS. Therefore, addition of the new layer will not impose so much burden on the manufacturing process.

The above-structured wavelength converting substrate and the TFT substrate manufactured through the generally employed process are bonded while interposing the liquid crystal, which are combined with the light source to provide the display device (liquid crystal display device). As a result of evaluating the display device, deterioration in image quality, for example, reduction in the contrast ratio may be suppressed even if the device is used under the environment with much external light like outdoor in the daytime.

According to the embodiment, the excitation light absorbing layer is laminated on the wavelength conversion layer at the external light side so as to allow provision of the display device with high brightness and high image quality even in the outdoor environment. Provision of the fluorescent scattering layer may further improve the external quantum efficiency.

The present invention is not limited to the embodiments as described above, and may include various modifications. The embodiments have been described in detail for better understanding of the invention, and are not necessarily restricted to the one provided with all the structures of the description. The structure of any one of the embodiments may be partially replaced with that of the other embodiment. Alternatively, it is possible to add the structure of any one of the embodiments to that of the other embodiment. It is also possible to have the part of the structure of the respective embodiments added to, removed from and replaced with the other structure.

It is to be understood that those who skilled in the art assume various changes and modifications while fully understanding of the gist of the present invention, which are regarded to be within the scope of the invention.

For example, those who skilled in the art are allowed to have the component added to, removed from, or the design changed with respect to any of the embodiments, or have the process step added to, removed from, or the condition changed with respect to any of the embodiments so long as they do not deviate from the scope of the invention.

It is to be understood that any other effect derived from the aforementioned embodiments whether it is obvious from the description or easily assumed by those who skilled in the art may be regarded to be provided by the present invention.

What is claimed is:

1. A display device comprising:
a light source;
a substrate transparent to a light source light radiated from the light source;
a pixel portion disposed on the substrate at a side irradiated with the light source light; and
a light extraction structure which extracts a light from the pixel portion to the outside, wherein:
the light extraction structure includes a wall-like structure and a reflection layer disposed along a side wall of the wall-like structure;
the pixel portion includes a laminated film formed by laminating a wavelength conversion layer which emits the light with longer wavelength than the wavelength of the light source light through radiation of the light source, and an excitation light absorbing layer disposed between the wavelength conversion layer and the substrate for suppressing transmission of the light with wavelength other than the one of the light with the longer wavelength; and
the laminated film is disposed in a region partitioned by walls of the wall-like structure.

2. The display device according to claim 1,
wherein the pixel portion further includes a stray light prevention layer for suppressing transmission of the light with wavelength other than the one of the light source light on the wavelength conversion layer at a side of the light source.

3. The display device according to claim 1,
wherein a black matrix is further disposed on the substrate on which the wall of the wall-like structure is mounted.

4. The display device according to claim 1,
wherein the pixel portion further includes a fluorescent scattering layer made of a transparent film having microparticles with high refractive index dispersed on the wavelength conversion layer at a side of the light source.

5. The display device according to claim 1,
wherein the reflection layer is disposed on both surfaces of the wall of the wall-like structure.

6. The display device according to claim 1,
wherein the reflection layer is disposed on one surface of the wall of the wall-like structure.

7. The display device according to claim 1,
wherein the reflection layer is disposed inside the wall of the wall-like structure.

8. The display device according to claim 1,
wherein the walls of the wall-like structure are arranged into a stripe pattern.

9. The display device according to claim 1,
wherein the walls of the wall-like structure are arranged into a waffle pattern.

10. The display device according to claim 1,
wherein the wall of the wall-like structure has a splay shaped proximal portion.

11. The display device according to claim 1,
wherein the wall of the wall-like structure has a perpendicular shaped proximal portion.

12. A display device comprising:
a light source;
a substrate transparent to a light source light radiated from the light source;
a first pixel portion, a second pixel portion and a third pixel portion which are disposed on the substrate at a side irradiated with the light source light; and
a light extraction structure for extracting the light from the first, the second, and the third pixel portions to the outside, wherein:
the light extraction structure includes a wall-like structure and a reflection layer disposed along a side wall of the wall-like structure;
the first pixel portion includes a first laminated film formed by laminating a first wavelength conversion layer for emitting a first light with longer wavelength than the wavelength of the light source light through radiation of the light source, and a first excitation light absorbing layer disposed between the first wavelength conversion layer and the substrate for suppressing transmission of the light with wavelength other than the one of the first light;
the second pixel portion includes a second laminated film formed by laminating a second wavelength conversion layer for emitting a second light with longer wavelength than the wavelength of the light source light through radiation of the light source, and a second excitation light absorbing layer disposed between the second wavelength conversion layer and the substrate for suppressing transmission of the light with wavelength other than the one of the second light;
the third pixel portion includes a light source light scattering layer made of a transparent film having microparticles with high refractive index dispersed; and
the first laminated film, the second laminated film and the light source light scattering layer are disposed in corresponding regions partitioned by the walls of the wall-like structure.

13. The display device according to claim 12,
wherein a third excitation light absorbing layer for suppressing transmission of an external light with wavelength other than the one of the light source light is disposed between the light source light scattering layer and the substrate.

14. A display device comprising:
a light source;
a substrate transparent to a light source light radiated from the light source;
a first pixel portion, a second pixel portion and a third pixel portion which are disposed on the substrate at a side irradiated with the light source light; and
a light extraction structure for extracting the light from the first portion, the second portion, and the third pixel portion to the outside, wherein:
the light extraction structure includes a wall-like structure and a reflection layer disposed along a side wall of the wall-like structure;
the first pixel portion includes a first laminated film formed by laminating a first wavelength conversion layer for emitting a first light with longer wavelength than the wavelength of the light source light through radiation of the light source, and a first excitation light absorbing layer disposed between the first wavelength conversion layer and the substrate for suppressing transmission of the light with wavelength other than the one of the first light;
the second pixel portion includes a second laminated film formed by laminating a second wavelength conversion layer for emitting a second light with longer wavelength than the wavelength of the light source light through radiation of the light source, and a second excitation light absorbing layer disposed between the second wavelength conversion layer and the substrate for suppressing transmission of the light with wavelength other than the one of the second light;
the third pixel portion includes a third laminated film formed by laminating a third wavelength conversion layer for emitting a third light with longer wavelength than the wavelength of the light source light through radiation of the light source, and a third excitation light absorbing layer disposed between the third wavelength conversion layer and the substrate for suppressing transmission of the light with wavelength other than the one of the third light; and
the first laminated film, the second laminated film and the third laminated film are disposed in corresponding regions partitioned by the walls of the wall-like structure.

15. The display device according to claim 14,
wherein each of the first pixel portion, the second pixel portion and the third pixel portion includes a stray light prevention layer for suppressing transmission of light with wavelength other than the one of the light source light on the first wavelength conversion layer, the second wavelength conversion layer and the third wavelength conversion layer at a corresponding side of the light source.
